(19) United States
(12) Patent Application Publication
(10) Pub. No.: US 2006/0075618 A1
(43) Pub. Date: Apr. 13, 2006

(54) Automatic nailing system

(75) Inventors: Michael D. Waidelich, Archbold, OH (US); Wendell R. Lanz, Stryker, OH (US)

Correspondence Address: EMCH, SCHAFFER, SCHAUB & PORCELLO CO, P O BOX 916, ONE SEAGATE SUITE 1980, TOLEDO, OH, 43697, US

(73) Assignee: Systech Handling, Inc.

(21) Appl. No.: 11/185,606

(22) Filed: Jul. 19, 2005

Related U.S. Application Data
(60) Provisional application No. 60/614,175, filed on Sep. 29, 2004.

(51) Int. Cl. B25C 5/02; B23P 17/00

(52) U.S. Cl. 29/417; 227/114; 29/809

(57) ABSTRACT

An automatic nailing system pulls wire from a coil, cuts the wire into lengths desired for the size of the respective items being nailed and delivers the nails to nailing guns which affix them to the pieces intended to be joined together.

### CROSS REFERENCE TO RELATED APPLICATION

This application is based upon and claims the benefit of U.S. Provisional Patent Application No. 60/614,175 filed Sep. 29, 2004.

The present invention is directed to an automatic nailing system which feeds wire from a spool, cuts it to the appropriate length and blows the cut nails to drivers (i.e. guns) which drive the nails into work pieces.

### BACKGROUND OF THE INVENTION

Prior art nailing systems or automatic nailing machines have utilized a variety of types of apparati for supporting and controlling movement of nails for delivery to a nailing gun which can rapidly and sequentially impact each nail to join two work pieces together. For example, U.S. Pat No. 4,863,089 is directed to a nail driving tool in which the nails are arranged side-by-side in a row and are connected together by collating wires which are welded to each nail. The strip or coil of wire collated nails is fed from a magazine such that the forwardmost nail in the row is located under the driver which advances to break the forwardmost nail from the strip or coil and drive it into a work piece.

U.S. Pat. No. 5,715,985 utilizes a vibratory bowl assembly to serially supply individual nails in a predetermined orientation to a holding station and then to a fastener drive gun. The holding station acts as a buffer to match the feed rate of the vibratory bowl assembly with the firing rate of the fastener drive gun.

U.S. Pat. No. 6,604,665 discloses a new collation strip of nails for use with a nailing gun. It can be used on a variety of environmental conditions without jamming the guns.

U.S. Pat. No. 5,542,886 discloses a process and apparatus for the production of star profile nails from a coil of wire.

### SUMMARY OF THE INVENTION

The present invention is directed to a method and apparatus for forming nails from a coil of wire and delivering them sequentially to one or more nailing guns. The apparatus cuts the wire to the length desired for the nails and immediately delivers each newly cut length of wire forming a nail to a distribution mechanism for delivery to one or more nailing guns. In a preferred embodiment, an indexing assembly is utilized with or included as part of the distribution mechanism. In another embodiment the distribution mechanism includes a shuttle. The distribution mechanism delivers nails one at a time to nailing gun(s). The nails are pneumatically moved through flexible tubes attached at one end to the distribution mechanism and at the other end to the head of each of nailing gun. With a nail positioned in the head of the nailing gun, a cylindrical driving member is actuated to drive the nail out of the head and into the work pieces to be joined.

The automatic nailing system includes a wire unwind unit for supporting a spool having a coil of wire, a feeder device for pulling wire from the coil, a cut-off unit for cutting the wire to desired lengths for the nails and a distribution mechanism for handling the cut lengths of wire (i.e. the nails) and delivering such lengths of wire to a nail driver or gun.

### IN THE DRAWINGS

FIG. 1 is an isometric view of the automatic nailing system of the present invention.

FIG. 2 is an isometric view of that portion of the system for feeding, cutting and distributing the cut lengths of wire.

FIG. 3 is a front view of that portion of the system shown in FIG. 2.

FIG. 4 is a side view thereof.

FIG. 5 is an isometric view of that portion of the system shown in FIG. 2 taken from the rear.

FIG. 6 is an exploded view of the indexing assembly portion of the system.

FIG. 7 is an isometric view of one gun nailer portion of the system.

FIG. 8 is a front view of the nailer gun of FIG. 7.

FIG. 9 is an enlarged view showing the nozzle front plate of the nail gun of FIG. 7.

FIG. 10A is a front view of a portion of the system with a modified wire feeder device for pulling wire from the coil.

FIG. 10B is a side view of the portion of the system shown in FIG. 10A.

FIG. 11A is a top view of a slider pin magazine for a modified embodiment of the wire distribution mechanism.

FIG. 11B is a front view of the slider pin magazine of FIG. 11A.

FIG. 11C is an end view of the slider pin magazine of FIG. 11A.

### DETAILED DESCRIPTION OF THE PREFERRED EMBODIMENTS

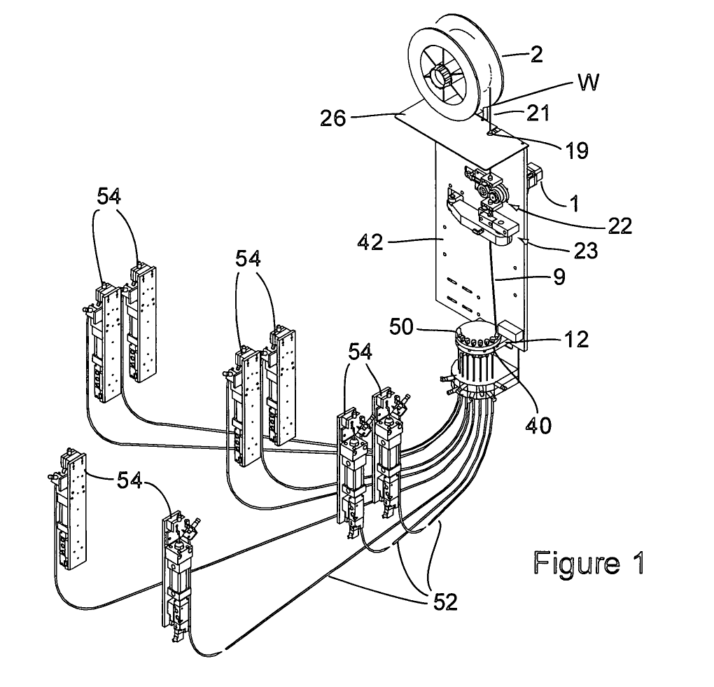

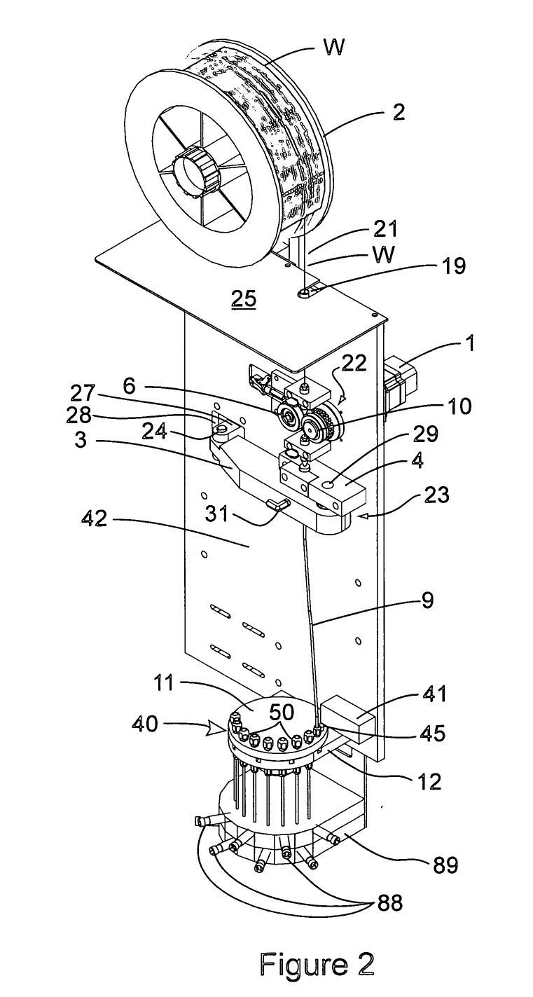

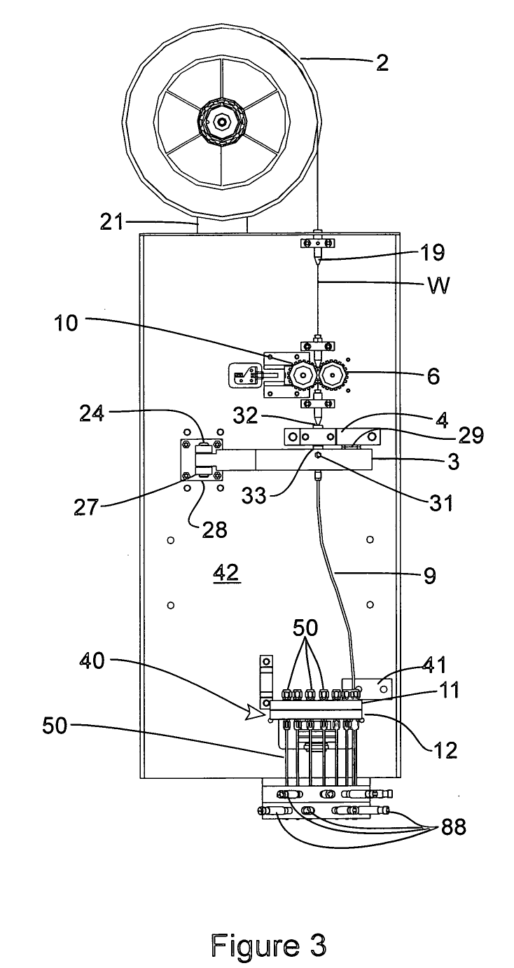

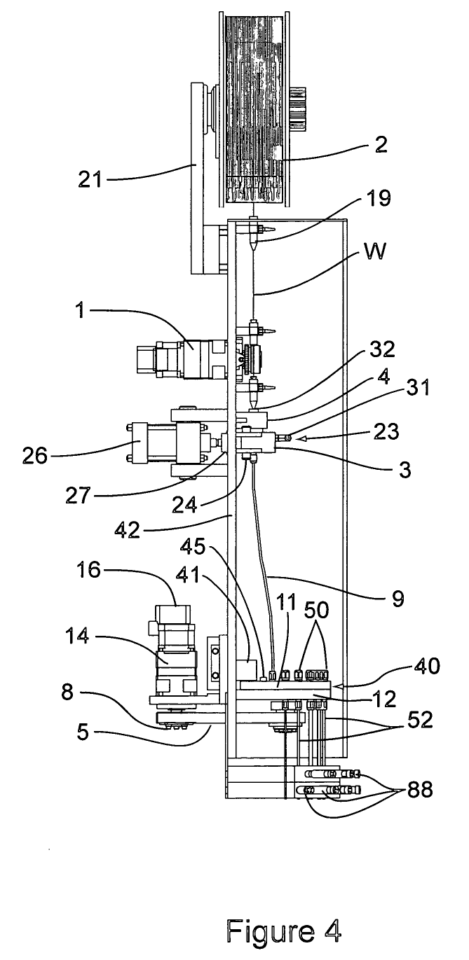

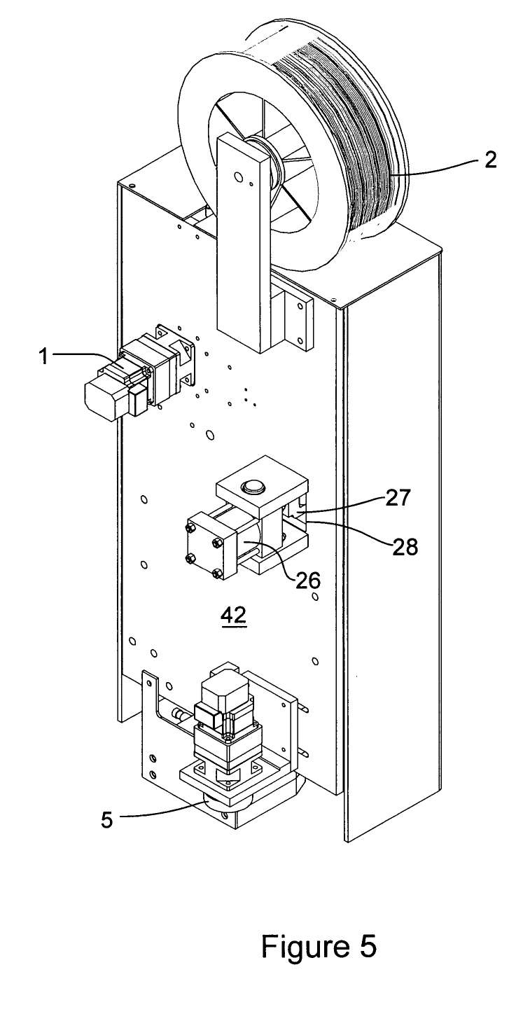

Referring to FIGS. 1-5, there is shown a schematic isometric view of the overall nailing system including a spool 2 containing a coil of wire W mounted on an unwind stand 21, a wire feeder mechanism 22, a wire cutter assembly 23, a wire distribution mechanism having an indexing assembly 40, and one or more nail guns 54. The unwind stand 21, wire feeder device 22, cut-off unit 23, and indexing assembly 40 are all mounted on a support plate 42. The support plate 42 has an upper horizontally extending plate 25 with an aperture through which the wire W is delivered to a guide tube 19.

The wire feeder mechanism 22 includes a drive roller 10 and an idle roller 6 which engage and pull the wire W from the spool 2. The drive roller 10 is powered by a servo motor 1 mounted on the opposite side of the support plate 42 therefrom.

The wire W is then directed to a cut-off unit 23 where it is cut to the desired length of nail for the specific members to be nailed together. The cut-off unit 23 includes an upper die half 4 mounted in fixed position on the support plate 42 and a lower die half 3 mounted for pivotal movement about a pin 29 affixed to and extending from the upper die half. The upper die half 4 has a bushing 32 and the lower die half 3 has a bushing 33, each of which is formed of hardened steel. Each of the bushings 32 and 33 has an aperture for receiving the wire W. The bushing 33 is mounted for sliding engagement relative to the bushing 32 upon movement of the lower die half 3. Movement of the lower die half 3 is effected by a pneumatic cylinder 26 mounted on the rear surface of the support plate 42, on the opposite side from the lower die half 3. An arm extends from the pneumatic cylinder 26 and is connected to a clevis 27 which extends through a hole 28 in the support plate 42 and is pivotally mounted by a pin 24 to one end of the lower die half 3. As previously stated, the other end of the lower die half 3 is pivotally mounted by a pin 29 extending from the bottom of the upper die half 4. Actuation of the cylinder 26 will cause the shaft and the clevis 27 carried thereby to extend away from the body of the cylinder 26 thereby pushing the end of the lower die half 3 secured to the clevis 27 away from the surface of the support plate 42. The lower die half 3 thus pivots about the pin 29 carrying with it the bushing 33 while the wire W is moving through apertures of the bushing 32 of the upper die half 4 and the bushing 33 of the lower die half 3. The lower die half 3 is thus moved from (a) a position at which the feed apertures of the upper die half 4 and lower die half 3 are aligned to permit the wire W to move therethrough to (b) a position at which such apertures are misaligned. The pivotal movement of the lower die half 3 to cause such apertures to become misaligned as the hardened steel bushing 33 moves in sliding engagement with the hardened steel bushing 32, results in cutting of the wire W to the proper length for the nails. A programmable logic controller such as one manufactured by Allen Bradley, division of Rockwell Automation may be used to control (a) the speed of the servomotor 1 and thus the speed of movement of the wire and (b) operation of the pneumatic cylinder 26 to obtain the desired length for nails being cut. Other programmable logic controllers may also be used.

Upon cutting, the nails are received in a feed tube 9 secured to the bottom of the bushing 33 in alignment with its aperture. Such alignment insures that the newly cut nails are directed to the feed tube 9. A fitting 31 connected to a source of pressurized air directs pressurized air to the aperture in the lower half 3 to eject the newly cut nails therefrom and into the feed tube 9. The lower end of the feed tube 9 is connected to an indexing plate 11 of the indexing assembly 40 to direct the newly cut nails thereto as hereinafter described.

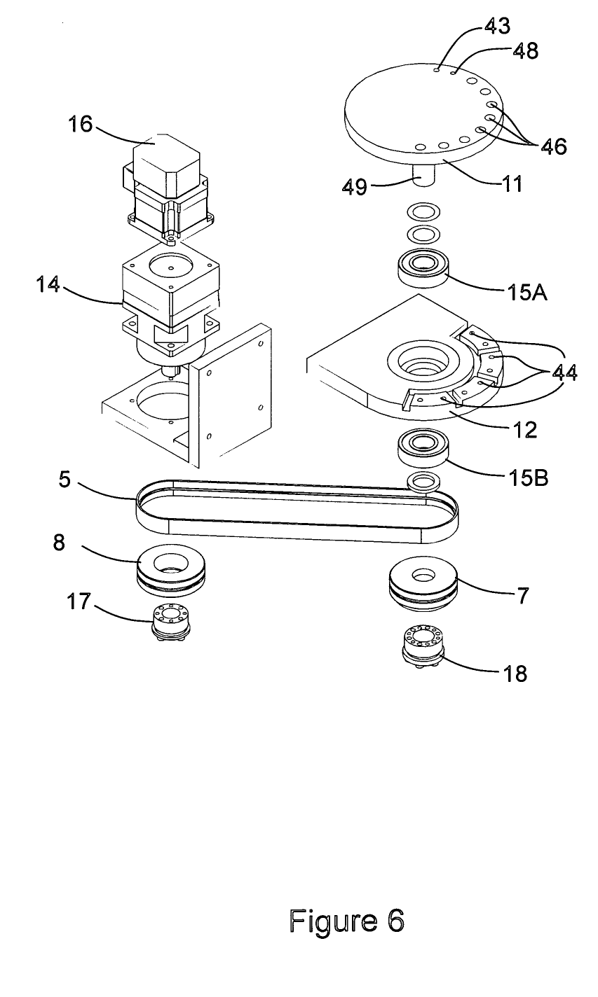

The indexing assembly 40 is positioned below the cut-off unit 23 and includes a mounting plate 12 rigidly secured to the support plate 42 and an indexing plate 11. The mounting plate 12 has a plurality, eight as shown in FIG. 6, of vertically apertures 44 extending therethrough. The indexing plate 11 is rotably mounted on the mounting plate 12 by a radial bearing 15A. The indexing plate 11 is provided with a plurality, eight as shown in FIG. 6, of large vertically extending holes 46 which are spaced apart the same as the spacing between the apertures 44 of the mounting plate 12 and so positioned on the indexing plate 11 that, upon appropriate rotational alignment, each of the holes 46 will be aligned with one of the apertures 44. There could be a greater or lesser number of apertures 44 and large holes 46 depending upon the number of nail guns 54 being supplied. The number of apertures 44, large holes 46 and nail guns 54 should be the same.

The indexing plate 11 also has another smaller vertically extending hole 48 to which is connected the lower end of the flexible feed tube 9. The smaller hole 48 functions as a nail feed hole to receive the cut lengths of wire, i.e. nails from the feed tube 9 and deliver them to the apertures 44 of the mounting plate 12.

The indexing plate 11 has a central shaft 49 extending downwardly therefrom and is rotatable to sequentially align the nail feed hole 48 with each of the apertures 44 of the mounting plate 12. Rotation of the indexing plate 11 is effected by means of a drive sprocket 7 mounted under the mounting plate 12 by a radial bearing 15B and shaft locking assembly 18 through which the shaft 49 extends. Power is delivered to the drive sprocket 7 through a drive belt 5 delivering rotational movement thereto from a second drive sprocket 8 connected to a planetary gear box 14 and powered by a servo motor 16.

The indexing plate 11 has a second small hole 43 which is adapted to receive a stop pin 45 positioned to contact a stop block 41 mounted on support plate 42. The stop block 41 in combination with the stop pin 45 serves to establish a homing position for the servo motor 16 controlling movement of the rotatable indexing plate 11.

Extending upwardly from each of the holes 46 of the indexing plate 11 is a compressed air tube connector 50. Air under pressure is delivered from a source (not shown) to the upper ends of each of the connectors 50.

As shown in FIG. 1, connected to the bottom of the mounting plate 12 are a plurality of nail distribution tubes 52 each of which is aligned with one of the apertures 44 of the mounting plate 12. As the indexing plate 11 rotates, a nail will be sequentially delivered from the wire or nail feed hole 48 to an aperture 44 of the mounting plate as such nail feed hole 48 becomes aligned therewith. When each of the apertures 44 has received a nail, the indexing plate 11 is rotated counterclockwise to a position at which each of the holes 46 is aligned with an aperture 44. The servo motor 16 is programmed with a programmable logic controller to assure correct alignment of the nail feed hole 48 successively with each of the apertures 44 and thereafter correct alignment of each hole 46 with apertures 44. When so aligned, air under pressure is delivered through the compressed air tube connectors 50 to force a nail from each aperture 44, through each of the nail distribution tubes 52 and into a nail gun 54. The nail guns 54 can then be actuated to simultaneously deliver a nail to the appropriate joined wood pieces to be nailed.

A plurality of sensors 88 are mounted on a bottom plate 89 fastened to the support plate 42. A sensor is provided for each of the nail distribution tubes 52 to confirm the delivery of nails through each nail distribution tube.

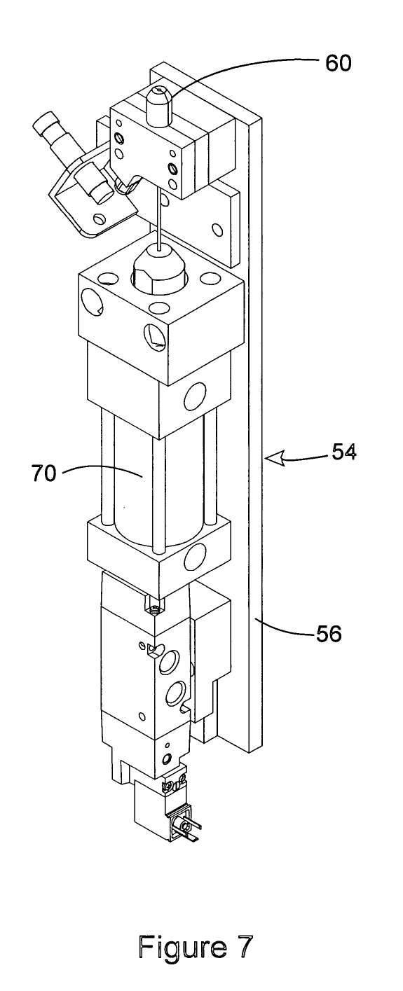

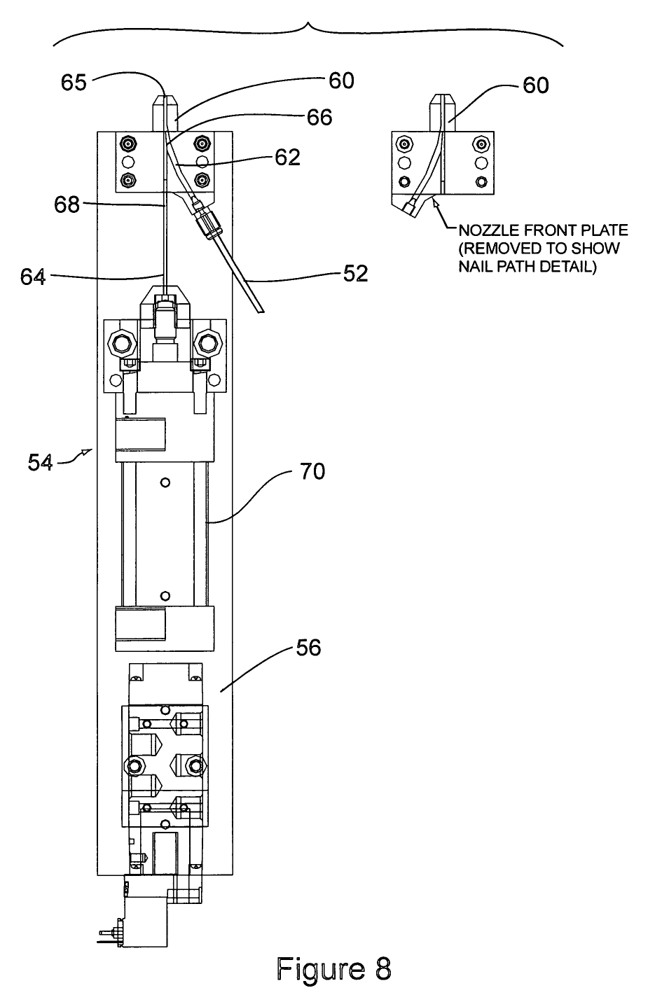

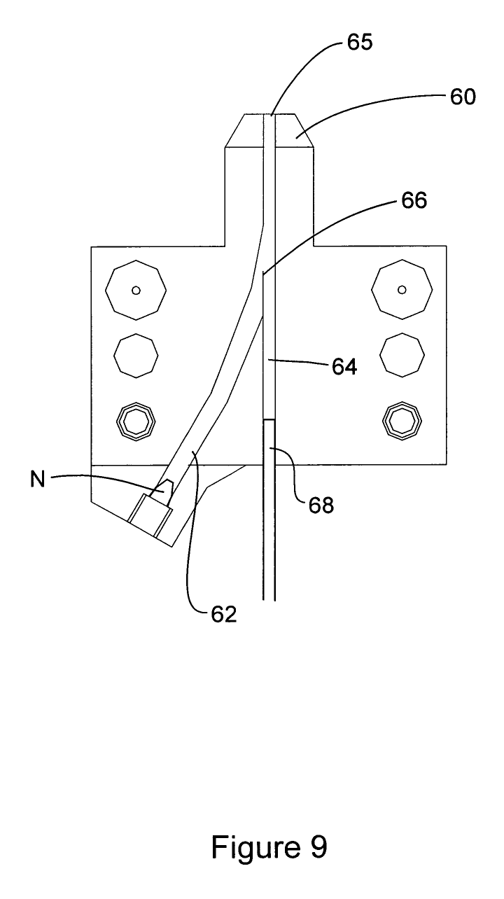

Referring to FIGS. 1 and 7-9, there is shown details of one of the nail guns 54 which receive the cut nails N from the nail distribution tubes 52 and nail them to the wood pieces being nailed together. The nail guns 54 are each mounted on a plate 56 and include a nozzle 60 for receiving nails N cut by the cut-off unit 23. The nails N are received from the nail tubes 52 connected to the nozzles 60. A nozzle 60, shown enlarged in FIGS. 8 and 9 (with the front plate removed to show nail path detail), has a first curved passageway 62 which intersects with a cylindrical passageway 64 at a juncture 66. The nails N are delivered under pressure to the curved passageway 62 by the nail distribution tube 52 connected thereto and are propelled to the cylindrical passageway 64 beyond the juncture 66. The cylindrical passageway 64 has an outlet 65 beyond the juncture 66 of the curved passageway 62 therewith and has positioned therein a plunger 68 on the opposite side of such juncture 66 from the outlet 65. The plunger 68 is slideably moveable in the cylindrical passageway 64 by means of a pneumatic cylinder 70 from a retracted positioned below the juncture 66 of the curved passageway 62 with the cylindrical passageway 64 (i.e. on the opposite side of such juncture 66 from the outlet 65) to an extended position substantially aligned with such outlet 65. Such movement from the retracted position to the extended position ejects the nail N from the outlet 65 thereby forcing the nail into the wood or other pieces being nailed. The nail N can either be set flush or recessed into the work piece.

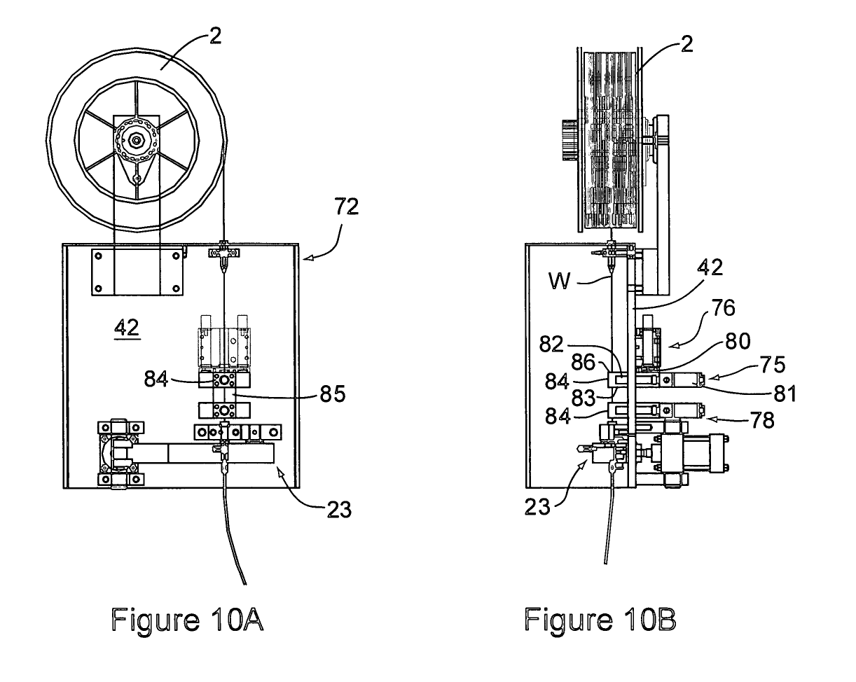

Referring to FIGS. 10A and 10B there is shown a modified embodiment of wire feeder mechanism utilizing a pneumatic system for pulling and advancing the wire from the spool 2, with FIG. 10A being a front elevational view and FIG. 10B being a side elevational view. The alternate embodiment of wire feeder includes three major mechanisms, namely (1) a movable clamp mechanism generally designated by the numeral 75, (2) a puller mechanism 76 and (3) a fixed clamp mechanism 78.

The puller mechanism 76 is rigidly mounted to the rear side of the support plate 42 which is the opposite side of the plate 42 from the wire W. It includes a thruster carrying a pneumatic cylinder which moves a piston rod and an enlarged head 80 attached thereto from a retracted raised position shown in FIGS. 10A and 10B to an extended lower position.

Mounted on the enlarged head 80 for movement therewith is the movable clamp 75. The movable clamp 75 includes a pneumatic cylinder 81 which moves a piston 82 between a retracted position shown in FIG. 10B and an extended position. The piston 82 is encased in a housing 83 on which is bolted an end plate 84. The end portion of the housing 83 extends through a slot 85 in the support plate 42. The housing 82 has a pair of apertures 86 immediately adjacent the end plate which apertures 86 are sufficiently large to permit the wire W to extend therethrough. Actuation of the cylinder 81 to move the piston 82 to its extended position, will clamp the wire W between the end of the piston 82 and the end plate 84.

The fixed clamp 78 is mounted in a fixed position to the support plate 42 immediately above the cut-off unit 23. Except for being mounted in a fixed position, the fixed clamp 78 is identical to the movable clamp 75, both of which are commercially available items of equipment manufactured and sold by Parker Hannifin Corporation of Wadsworth, Ohio under its SR Series. The puller 76 is also a commercial item of equipment available from Parker Hannifin as its P5T Series.

In order to pull a length of wire W from the spool 2, the pneumatic cylinder 81 is actuated to extend the piston 82 to clamp the wire W against the end plate 84. The puller 76 will then be actuated to extend its piston rod and the enlarged head 80 carried thereby to an extended position carrying the moveable clamp 75 toward the fixed clamp 78 and pulling with it the clamped wire W. During such movement, the piston 82 of the fixed clamp will be in the retracted position so that the wire W can move through its apertures 86 for delivery to the cut-off unit 23. When the movable clamp 75 has been moved downwardly the desired distance for the length of nail being cut, the cylinder of the fixed clamp 78 will be actuated to move its piston 82 to an extended position to clamp the wire W against its end plate 84 at which time the cut-off unit 23 can be actuated to cut a length of the wire W to the desired length for the nails being formed. At the same time, the piston 82 of the movable clamp 75 is retracted by actuation of cylinder 81 to release the wire W. With the wire W released from any clamping action of the movable clamp 75, the puller 76 is actuated to retract its piston rod and enlarge head 80 thereby pulling the movable clamp 75 to its raised position preparatory to clamping the wire W for the next cycle. A program logic controller controls the sequence of actuation of the pneumatic cylinders.

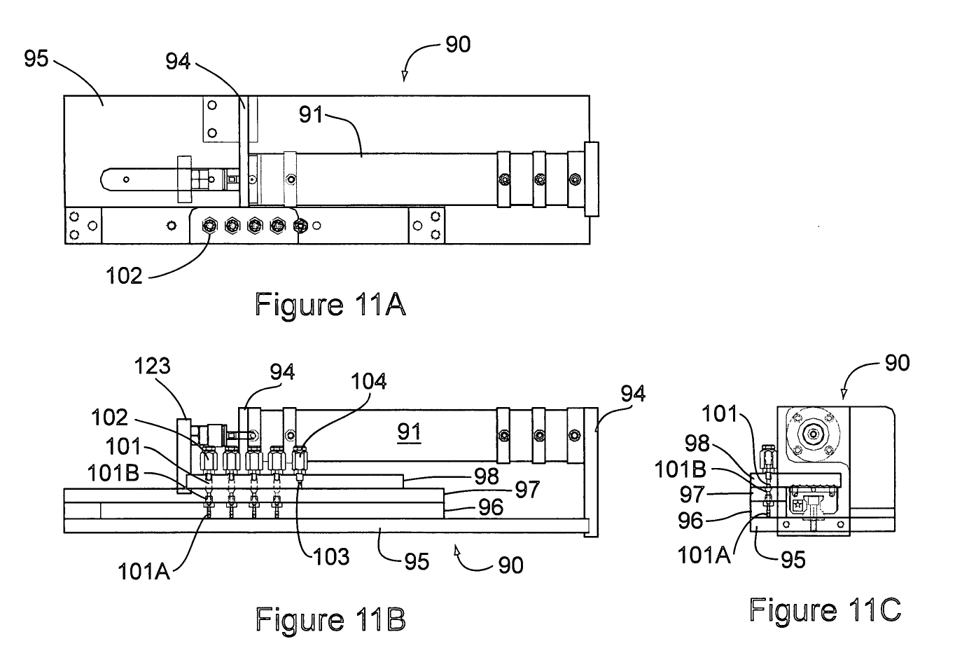

Referring to FIGS. 11A, 11B and 11C there is shown a modified assembly for distributing nails to the nail guns 54. Shown in the figures is a slider pin magazine generally designated by the numeral 90 which may be used in place of the indexing mechanism 40 previously described. The slider pin magazine 90 includes a commercially available pneumatic cylinder manufactured and sold by Bimba Cylinders of Monee, Ill. The pneumatic cylinder 91 is supported on a pair of cylinder support plates 94 which are mounted on a steel base plate 95.

Supported on the base plate 95 is a spacer block 96, a hardened steel plate 97 positioned thereon and a moveable plate 98 formed of bronze aluminum. The moveable plate 98 is fastened at one end to a connector plate 123 mounted one the end of the ram of the cylinder 91. Actuation of the cylinder 91 moves its ram, the connector plate 123 and the moveable plate 97. The spacer block 96 and the steel plate 97 remain in a fixed position.

The moveable plate 98 has a plurality of holes 101 and an air fitting 102 mounted at the upper end of each hole 101. The spacer plate 96 and the steel plate 97 have nail receiving holes 101A and 101B, respectively, equal in number to and spaced apart the same as holes 101. The base plate 95 has a cut out 105 in the area underlying nail receiving holes 101A and 101B. As shown in FIGS. 11A and 11B, there are four sets of nail receiving holes 101A and 101B. Nail distribution lines are connected to the nail receiving holes 101A in spacer plate 96 to direct nails to four nail guns. There could be a greater or fewer number of nail receiving holes 101A and 101B depending upon the number of nail guns intended to be fed.

In addition to the holes 101, the moveable plate 98 has a nail feed hole 103 which sequentially receives a nail from the cut-off unit as described in the previous embodiment. Following receipt of a nail in the nail feed hole 103, the pneumatic cylinder 91 is actuated to slide the moveable plate 98 to sequentially position the nail feed hole 103 over the nail receiving holes 101B and 101A for delivery thereto. An air fitting 104 is also mounted on the nail feed hole 103 to eject nails successively from the nail feed hole 103 to the respective nail receiving holes 101B and 101A. The air fitting 104 is provided with an aperture through which a nail can pass as it is delivered to the nail feed hole 103. The movement of the slideable plate 98 and the air fittings 102 mounted thereon is controlled by the cylinder 91, the actuation of which to its sequential stop and start positions is controlled by a programmable logic controller. When each of the nail receiving holes 101 B has received a nail, the pneumatic cylinder 91 is actuated to slide the plate 98 to a position at which each of the holes 101 and air fitting 102 is aligned with a nail receiving hole 101B and the underlying hole 101A. Then air under pressure is directed through the air fittings 102 to eject the nails from such nail receiving holes 101B and 101A through nail distribution lines connected to the nail receiving holes 101A to the respective nail guns as previously described.

The automatic nailing system of the present invention has many benefits over traditional collated nailing systems or precut nailing systems. These include:
This system provides continuous production eliminating down time to load collated nail strips.
The cost of the wire on the coil is significantly less than collated strips or precut bulk nails.
Blow feeding the individual nails allows the nail guns to be mounted within an automated machine in tight spaces where conventional system will not fit.
Programmable nail lengths in that various lengths could be sent to various nail gun locations from the same spool.
Programmable nailing sequence, i.e. not all of the nail guns are necessarily used at the same time.

Many modifications will be readily apparent to those skilled in the art. Accordingly, the scope of the present invention should be limited only by the scope of the claims.

I claim:

1. A nailing system comprising:
(a) a feeder for delivering wire from a supply;
(b) cutters for cutting said wire to form nails each having a length extending from a first end to a second end;
(c) a distribution mechanism block for receiving said nails;
(d) at least one gun for receiving said nails and driving them into articles; and
(e) at least one guide tube for receiving said nails from said distribution mechanism and delivering them to said at least one gun.

2. The nailing system according to claim 1 wherein said distribution mechanism includes:
(a) a fixed member having one or more apertures extending therethrough; each said aperture sized to receive a nail at a first end and dispense said nail from a second end;
(b) a rotatable plate engageable with said fixed member and rotatable relative thereto, said rotatable plate having
(i) a first hole extending therethrough, said first hole being so positioned as to become aligned sequentially with said apertures upon rotation of said plate, said first hole receiving nails one at a time by means of delivery means engageable therewith for moving said nails between said cutters and said first hole, said nails being delivered sequentially to apertures upon alignment of said first hole therewith, and
(ii) one or more second holes, the number of said second holes being at least equal to the number of said apertures, said second holes being at least equal to the number of said apertures, said second holes being so positioned that, when said plate is in one rotatable position, each of said apertures will have aligned therewith a second hole.

3. The nailing system according to claim 2 further including means engaged to each of said second holes for delivering pressurized fluid therethrough for ejecting a nail therefrom to said guide tube and said gun.

4. The nailing system according to claim 1 wherein said at least one gun includes a nozzle having a first passageway following a straight line path and having an exit, a second passageway disposed at an angle to and from said exit, said guide tube connected to said second passageway for delivering nails thereto, a plunger in said first passageway and movable therein from a position on the opposite side of said intersection from said exit to a position between said intersection and said exit.

5. The nailing system according to claim 1 wherein said at least one gun includes a nozzle having a first passageway following a straight line path and having an exit, a second passageway disposed at an angle to and intersecting with said first passageway at an area of intersection spaced from said exit, said guide tube connected to said second passageway for delivering nails thereto, a plunger in said first passageway and movable therein from a position on the opposite side of said intersection from said exit to a position between said intersection and said exit.

6. The nailing system according to claim 1 wherein said cutters include:
(i) a fixed member having a recess or an aperture for receiving wire from said feeder and
(ii) a second member having a cutting edge slidingly engaged to fixed member at said recess or aperture.

7. The nailing system according to claim 6 wherein said second member is mounted for pivotable movement relative to said fixed member, said pivotable movement moving said cutting edge relative to said aperture or recess to cut wire extending therethrough.

8. The nailing system according to claim 6 wherein said second member has an aperture or recess movable from a first position aligned with said first member aperture or recess to a second position misaligned therewith, movement from said first position to said second position cutting wire extending through said first and second members.

9. The nailing system according to claim 1 wherein said feeder includes a first roller and a second roller rotatable in engagement with first roller to pinch said wire therebetween.

10. The nailing system according to claim 1 wherein said feeder includes:
(a) a first power unit for moving an engagement member from a retracted position to an extended position
(b) a first gripper unit having a second power unit, a housing attached to said engagement member, an end on said housing, openings in said housing adjacent said end, said wire movable through said openings, a plunger in said housing, said plunger movable upon actuation of said second power unit from a retracted position spaced from said end to an extended position clamping said wire against said end, movement of said engagement member when said plunger is extended to clamp said wire against said end, pulling said wire from said supply.

11. The nailing system according to claim 10 further including a second gripper unit positioned between said first gripper unit and said cutters, a third power unit, said second gripper unit including a second housing, a second housing end, apertures in said second housing adjacent said second housing end, said wire movable through said apertures, a plunger rod in said housing, said plunger rod movable upon actuation of said third power unit from a retracted position spaced from said end to an extended position clamping said wire to said end.

12. The nailing system according to claim 1 wherein said distribution mechanism includes a shuttle member movable along a straight line path, said shuttle member having a nail feed hole for receiving nails from said cutters.

13. The nailing system according to claim 12 wherein there is provided a plurality of guide tubes and further including a receiving member having a plurality of nail receiving holes in communication with said guide tubes, said shuttle member being moveable relative to said receiving member to sequentially deliver nails from said nail feed hole to said nail receiving holes.

14. A nail gun comprising:
(a) a body portion;
(b) a first passageway extending along a straight line path to an exit opening;
(c) a second passageway extending at an angle relative to said first passageway and intersecting said first passageway at a juncture spaced from said exit opening;
(d) a plunger positioned in said first passageway and movable therein from a first position spaced from said exit opening on the opposite side of said juncture from said exit opening to a second position beyond said juncture.

15. A nail gun according to claim 14 wherein said second position is in the vicinity of or spaced outwardly from said exit opening.

16. A nail gun according to claim 15 wherein a nail delivered into said second passageway is moved to said first passageway when said plunger is on the opposite side of said juncture from said exit opening and, when so positioned in said first passageway, may be ejected from said gun upon movement of said plunger toward said exit opening.

17. A method for delivering a nail to a nail gun and expelling it therefrom comprising the step of:
(a) propelling said nail along a first path;
(b) changing the direction of movement of said nail to a second straight line path;
(c) providing a plunger along said second straight line path; and
(d) moving said plunger along said second straight line path following said step of changing direction.

18. A method for supplying nails to a nail gun comprising the steps of:
(a) feeding a length of wire to a cutter;
(b) successively cutting said wire to form nails of a desired length;
(c) feeding said nails to a tubular member; and
(d) pneumatically propelling said nails through said tubular member to a nail gun.

19. A method for supplying nails to nail guns comprising the steps of
(a) feeding a length of wire to a cutter;
(b) successively cutting said wire to form nails of a desired length;
(c) feeding said nails to a distribution member;
(d) successively delivering single ones of said nails to one of a plurality chambers; and
(e) pneumatically propelling said nails from said retaining chamber to said nail guns.

20. The method according to claim 19 wherein a plurality of said nails are propelled from said retaining chambers simultaneously.
